(19) United States
(12) Patent Application Publication
(10) Pub. No.: US 2023/0064379 A1
(43) Pub. Date: Mar. 2, 2023

(54) Pet Grooming Restraint Device

(71) Applicant: Jane Helms, Monroe, VA (US)

(72) Inventor: Jane Helms, Monroe, VA (US)

(21) Appl. No.: 17/715,197

(22) Filed: Apr. 7, 2022

Related U.S. Application Data
(60) Provisional application No. 63/240,082, filed on Sep. 2, 2021.

(51) Int. Cl. A01K 15/04

(52) U.S. Cl. CPC A01K 15/04

(57) ABSTRACT

The invention relates to a pet grooming restraint device comprised of a base and curved member, and further comprised of a pair of frame arms, a first curved member, a second curved member and a pin. The base can further be secured to a grooming table, wherein the curved members can be secured around the neck of a pet in order to secure the pet to the device. As a result, the pet cannot struggle or move during grooming. In differing embodiments, the curved members may have an adjustable clasp, an adjustable buckle, a prong and a plurality of continuous openings or magnets to allow the curved members to attach around the neck of a pet.

### CROSS-REFERENCE TO RELATED APPLICATION

The present application claims priority to, and the benefit of, U.S. Provisional Application No. 63/240,082, which was filed on Sep. 2, 2021 and is incorporated herein by reference in its entirety.

### FIELD OF THE INVENTION

The present invention relates generally to the field of animal restraints. More specifically, the present invention relates to a pet grooming restraint device primarily comprised of a base and curved member, further comprised of a pair of frame arms, a first curved member, a second curved member and a pin. The base can further be secured to a grooming table, wherein the curved members can be secured around the neck of a pet in order to secure the pet to the device. As a result, the pet cannot struggle or move during grooming. In differing embodiments, the curved members may have an adjustable clasp, an adjustable buckle, a prong and a plurality of continuous openings or magnets to allow the members to attach around the neck of a pet. Accordingly, the present disclosure makes specific reference thereto. Nonetheless, it is to be appreciated that aspects of the present invention are also equally applicable to other like applications, devices and methods of manufacture.

### BACKGROUND

Pets such as dogs and cats must be regularly groomed. Many pet owners take their pets to professional pet grooming salons. At said salons, pets are normally groomed on raised grooming tables. During grooming, many pets are exceedingly nervous and anxious. In an effort to prevent nervous or anxious pets from biting or scratching a pet groomer, grooming tables are often equipped with a slip collar that can be placed around the neck of the pet in order to restrain the movement of the pet. However, if a pet accidently falls off a grooming table, the slip collar attached to the grooming table may suffocate and kill the pet.

Therefore, there exists a long-felt need in the art for an improved means to restrain a pet on a grooming table. There also exists a long-felt need in the art for a pet grooming restraint device that can be universally applied to all pet grooming tables. Further, there exists a long-felt need in the art for a pet grooming restraint device that can be universally applied to all pet grooming tables and that does not pose a risk of suffocating a pet, if said pet falls off the grooming table. Finally, there exists a long-felt need in the art for a pet grooming restraint device that can accommodate a wide range of pets of varying sizes.

The subject matter disclosed and claimed herein, in one embodiment thereof, comprises a pet grooming restraint device. The device is primarily comprised of a base and curved member, further comprised of a pair of frame arms, a first curved member, a second curved member and a pin. The base can further be secured to a grooming table, wherein the curved members can be secured around the neck of a pet in order to secure the pet to the device. As a result, the pet cannot struggle or move during grooming. In differing embodiments, the curved members may have an adjustable clasp, an adjustable buckle, a prong and a plurality of continuous openings or magnets, to allow the curved members to attach around the neck of a pet. Further, one embodiment of the device may have a magnetic collar that can be placed around the neck of a pet, such that the collar is magnetically secured to the curved member of the base.

In this manner, the pet grooming restraint device of the present invention accomplishes all of the forgoing objectives and provides an improved means to restrain a pet on a grooming table. The device can further be universally applied to all pet grooming tables, wherein the device does not pose a risk of suffocating a pet, if said pet falls off of the grooming table. Finally, the device is adjustable such that it can accommodate a wide range of pets of varying sizes.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet grooming restraint device. The device is primarily comprised of a base and curved member, further comprised of a pair of frame arms, a first curved member, a second curved member and a pin. The base is comprised of a flat bottom member that rests on the surface of a grooming table, wherein the member may be magnetic, such that it can magnetically attach to the grooming table surface in a removable fashion. The bottom member may also be comprised of at least one continuous opening that can receive a fastener, to allow the bottom member to be fixedly or removably-secured to a grooming table surface. A pair of generally parallel, vertical frame arms are further fixedly or removably-attached to the bottom member, wherein each frame arm is comprised of an inner sleeve covered by an outer sleeve. The outer sleeve or both sleeves are comprised of a plurality of aligned continuous openings, such that a pin can be inserted into one of the openings to allow the outer sleeve to be set at a specific height, such that the bottom member can rest under the neck of a pet.

The device is also comprised of a first curved member and a second curved member that are further fixedly or removably-attached to the curved member of the base via at least one hinge. In differing embodiments, both curved members may be flexible, semi-rigid or rigid and may be made of a plastic material, a durable metal or a fabric. The second end of each member is further preferably comprised of at least one magnet. One magnet is preferably located on the top surface of the first member, and another magnet is located on the bottom surface of the second member, such that the magnets can be used to secure each curved member around the neck of an animal, such that the animal is secured by both members and the curved member of the base within the device. As a result, the animal cannot move or struggle while on a grooming table during grooming.

Each curved member may further be comprised of an additional or alternative means to secure the members around a pet's neck. Said means can include an adjustable clasp, an adjustable buckle, a prong and a plurality of continuous openings. In addition, one embodiment of the device may feature a continuous body instead of a first curved member and a second curved member. In a further additional embodiment of the device, the curved member of the base is magnetic, such that a magnetic collar can attach to the member to secure a pet to the device. The collar may have at least one embedded magnet and/or an adjustable buckle, a clip, a prong and a plurality of continuous openings, etc.

Accordingly, the pet grooming restraint device of the present invention is particularly advantageous as it can be universally applied to all pet grooming tables. Further, the device does not pose a risk of suffocating a pet if said pet falls off the grooming table. Finally, the device is adjustable such that it can accommodate a wide range of pets of varying sizes.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the pet grooming restraint device of the present invention in an open position in accordance with the disclosed architecture;

FIG. 2 illustrates a perspective view of one potential embodiment of the pet grooming restraint device of the present invention in a closed position in accordance with the disclosed architecture;

FIG. 3 illustrates a perspective view of one potential embodiment of the pet grooming restraint device of the present invention in use around a pet in accordance with the disclosed architecture;

FIG. 4 illustrates a perspective view of one potential embodiment of the pet grooming restraint device of the present invention in a closed position with a clasp in accordance with the disclosed architecture;

FIG. 5 illustrates a perspective view of one potential embodiment of the pet grooming restraint device of the present invention in a closed position with a buckle in accordance with the disclosed architecture;

FIG. 6 illustrates a perspective view of one potential embodiment of the pet grooming restraint device of the present invention in a closed position with a prong buckle in accordance with the disclosed architecture; and

FIG. 7 illustrates a perspective view of one potential embodiment of the pet grooming restraint device of the present invention for a small pet in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved means to restrain a pet on a grooming table, that can be universally applied to all pet grooming tables. Further, there exists a long-felt need in the art for a pet grooming restraint device that can be universally applied to all pet grooming tables and that does not pose a risk of suffocating a pet, if said pet falls off a grooming table. Finally, there exists a long-felt need in the art for a pet grooming restraint device that can accommodate a wide range of pets of varying sizes.

The present invention, in one exemplary embodiment, is comprised of a pet grooming restraint device primarily comprised of a base and curved member and further comprised of a pair of frame arms, a first curved member, a second curved member, and a pin. The base is comprised of a flat bottom member that rests on the surface of a grooming table, wherein the member may be magnetic such that it can magnetically attach to the grooming table surface in a removable fashion. The bottom member may also be comprised of at least one continuous opening, that can receive a fastener to allow the bottom member to be fixedly or removably-secured to a grooming table surface. A pair of generally parallel, vertical frame arms are further fixedly or removably-attached to the bottom member, wherein each frame arm is comprised of an inner sleeve covered by an outer sleeve, wherein the outer sleeve or both sleeves are comprised of a plurality of aligned continuous openings, such that a pin can be inserted into one of the openings. Once inserted into one of the openings, the pin allows the outer sleeve to be set at a specific height, such that the bottom member can rest under the neck of a pet.

The device also has a first curved member and a second curved member. Both members are further fixedly or removably-attached to the curved member of the base via at least one hinge. In differing embodiments, both curved members may be flexible, semi-rigid or rigid and may be comprised of a plastic material, a durable metal or a fabric. The second end of each member is further preferably comprised of at least one magnet, wherein the magnet is preferably located on the top surface of the first member, and the other magnet is located on the bottom surface of the second member. The magnets can then be used to secure each curved member around the neck of an animal, such that the animal is secured by both members and the curved member of the base within the device. Therefore, the animal cannot move or struggle while on a grooming table during grooming.

Each curved member may further be comprised of an additional or alternative means to secure the members around a pet's neck, including an adjustable clasp, an adjustable buckle, and a prong and a plurality of continuous openings. Further, one embodiment of the device may feature a continuous body, instead of a first curved member and a second curved member. In an additional embodiment of the device, the curved member of the base is magnetic, such that a magnetic collar can attach to the member. The collar may have at least one embedded magnet and/or an adjustable buckle, a clip, a prong and a plurality of continuous openings, etc. As a result, a pet wearing the collar can be magnetically-attached to the curved member, and thus secured to the device during grooming.

Accordingly, the pet grooming restraint device of the present invention is particularly advantageous as it can be universally applied to all pet grooming tables. Further, the device does not pose a risk of suffocating a pet, if said pet falls off a grooming table. Finally, the device is adjustable, such that it can accommodate a wide range of pets of varying sizes.

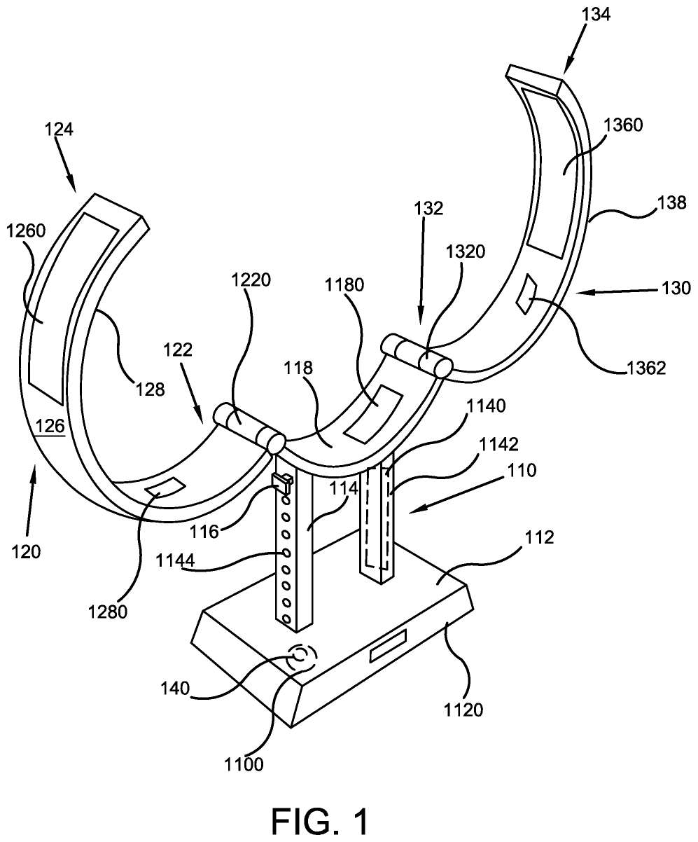

Referring initially to the drawings, FIGS. 1-3 illustrate a perspective view of one embodiment of the pet grooming restraint device 100 of the present invention. The device 100 is primarily comprised of a base 110 and a curved member 118, and further comprised of a pair of frame arms 114, a first curved member 120, a second curved member 130 and a pin 116. It is contemplated that in one embodiment, the base 110, frame arms 114, pin 116 and curved member 118 are comprised of a durable metal, such as but not limited to, stainless steel or aluminum, etc., or any other suitable metal as is known in the art. In addition, the base 110, frame arms 114, pin 116, and curved member 118 may be comprised of a plastic material, such as but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc., or any other suitable plastic material as is known in the art.

The base 110 is comprised of a flat bottom member 112 that rests on the surface of a grooming table 20. In one embodiment, the bottom surface 1120 of the bottom member 112 may be magnetic, such that the bottom member 112 can magnetically attach to the grooming table surface in a removable fashion. In a differing embodiment, the bottom member 112 may be comprised of at least one continuous opening 1100, that can receive at least one fastener 140, such as but not limited to, a bolt, nut, screw, etc., to allow the bottom member 112 to be fixedly or removably-secured to a grooming table 20 surface.

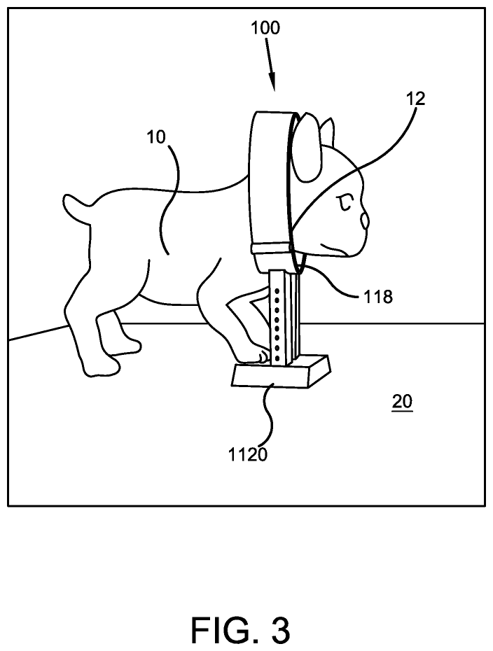

A pair of generally parallel, vertical frame arms 114 are further fixedly or removably-attached to the bottom member 112. Each frame arm 114 is comprised of an inner sleeve 1140 covered by an outer sleeve 1142, wherein the outer sleeve 1142 or both sleeves 1140, 1142 are comprised of a plurality of aligned continuous openings 1144. A pin 116 can then be inserted into one of the openings 1144 to allow the outer sleeve 1142 to be set at a specific height, such that the curved member 118 can rest under the neck 12 of a pet (as best seen in FIG. 3). In this manner, the device 100 can be adjusted for any size (i.e. height) of pet or animal.

A first curved member 120 and a second curved member 130 are further fixedly or removably-attached to the curved member 118 via at least one hinge 1220, 1320 located on the first end 122, 132 of each curved member 120, 130. In differing embodiments, each hinge 1220, 1320 may be in the form of an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc., or any other suitable hinge as is known in the art. In differing embodiments, both curved members 120, 130 may be flexible, semi-rigid or rigid.

In addition, both curved members 120, 130 may be comprised of a plastic material, such as but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc., or any other suitable material as is known in the art. Both curved members 120, 130 may also be comprised of a durable metal, such as, stainless steel or aluminum, or a fabric, such as but not limited to: vinyl, canvas, cashmere, chenille, chiffon, cotton, damask, jersey, lace, linen, wool, modal, polyester, satin, silk, spandex, suede, tweed, twill, velvet, acrylic, modacrylic, nylon, polypropylene, polyurethane, polyvinyl chloride, polyethylene, vinylidene, benzoate, aramid, rayon, acetate, triacetate, etc.

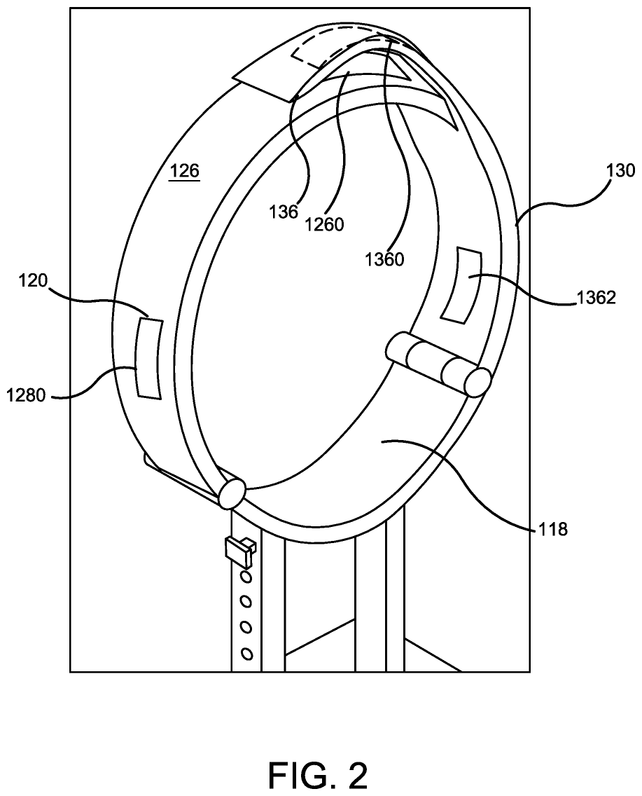

FIG. 2 illustrates a perspective view of one embodiment of the pet grooming restraint device 100 of the present invention in a closed position. The second end 124, 134 of each curved member 120, 130 is further preferably comprised of at least one magnet 1260, 1360, wherein one magnet 1260 is located on the top surface 126 of the first curved member 120, and the other magnet 1360 is located on the bottom surface 136 of the second curved member 130. In this manner, the magnets 1260, 1360 can be used to secure each curved member 120, 130 around the neck 12 of an animal 10, such that the animal is secured by both curved members 120, 130, and the curved member 118 within the device 100. To this effect, the pet 10 cannot move or struggle while on a grooming table 20 during grooming. It is further contemplated that the curved member 118, the bottom surface 128 of the first curved member 120 and the bottom surface 136 of the second curved member 130 may be comprised of padding 1180, 1280, 1362 to ensure the comfort of the pet 10, while the curved members 118, 120, 130 contact the pet's 10 neck 12, as shown in FIG. 1.

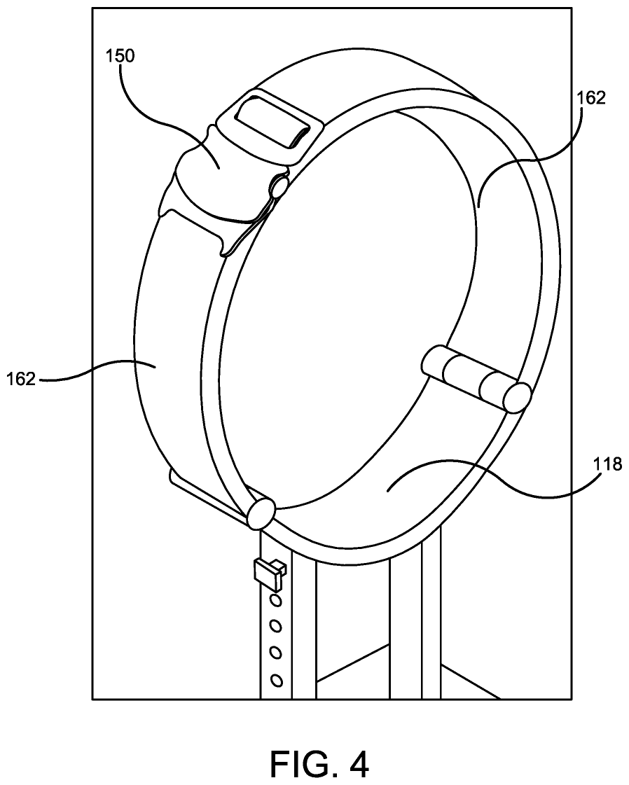

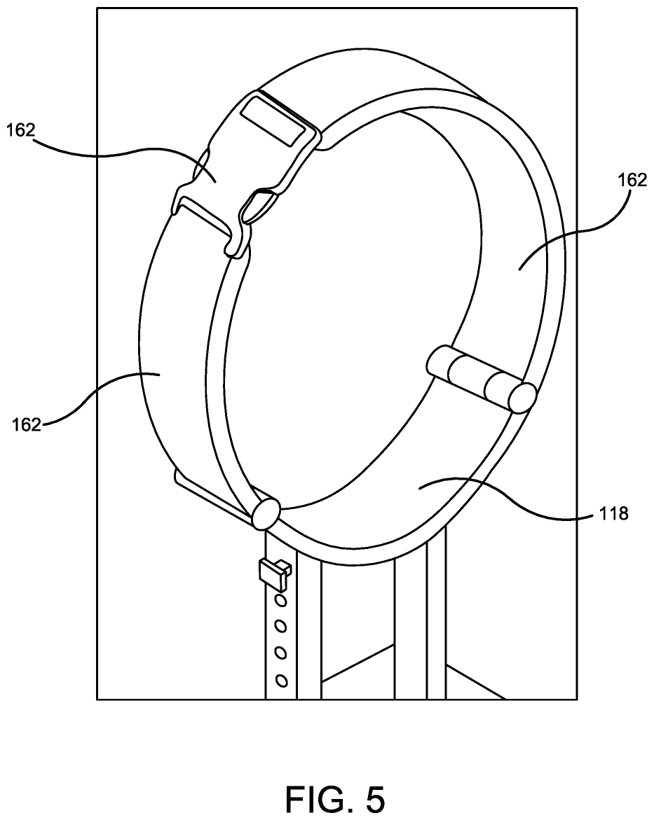

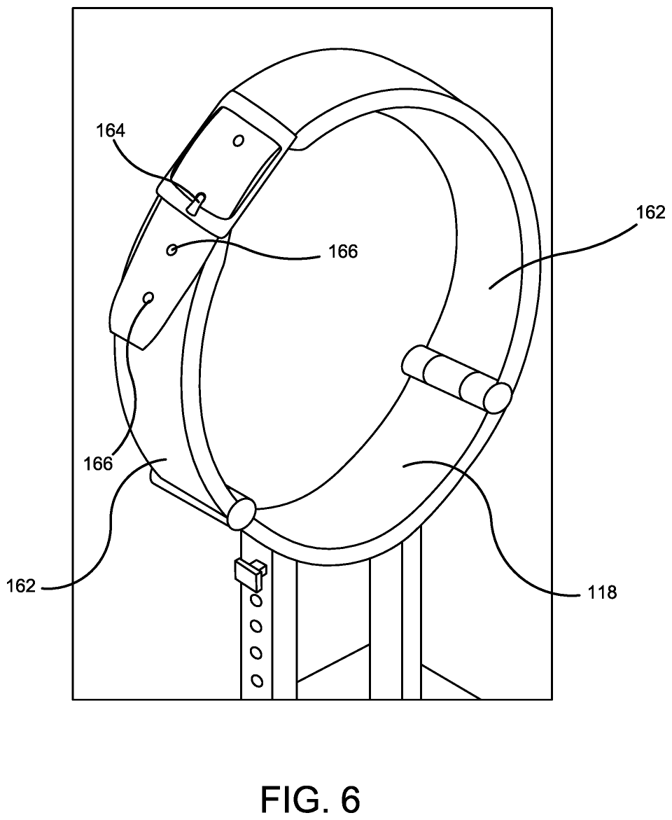

It should be further appreciated that in any embodiment, each curved member 120, 130 may be comprised of an additional or alternative means to secure the curved members 120, 130 around a pet's 10 neck 12. Said means can include an adjustable clasp 150 located on the top surface 126, 138 of both curved members 120, 130, as seen in FIG. 4. Further, said means can include an embodiment, wherein both curved members 120, 130 are one continuous body 160. In this embodiment, the body 160 can be tightened around the neck 12 of a pet 10 via an adjustable buckle 162 (shown in FIG. 5), a prong 164 and a plurality of continuous openings 166 (shown in FIG. 6). However, the buckle 162 and prong 164 and opening 166 structures may also be found on an embodiment of the device 100 with two separate curved members 120, 130 and not one continuous body 160. It should be appreciated that in any embodiment, each curved member 120, 130 or the continuous body 160 may be comprised of any dog collar-like structure or any features related to the adjustability or the fastening of a collar around a pet as is known in the art. In any of said alternative embodiments, the device 100 may not be comprised of any hinges 1220, 1320.

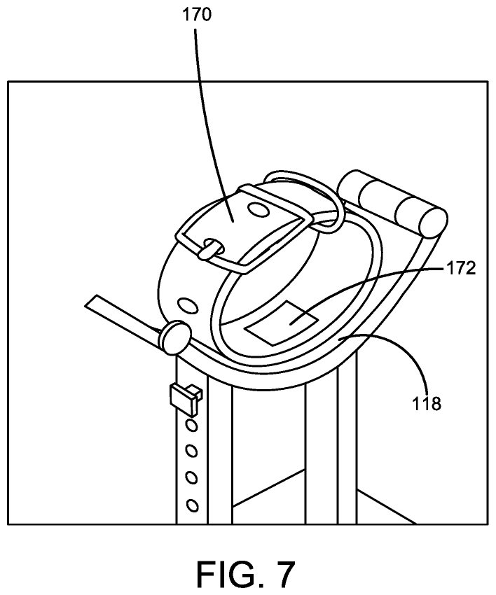

FIG. 7 illustrates a perspective view of one embodiment of the pet grooming restraint device of the present invention. In another embodiment of the device 100, the device 100 may lack any curved members 120, 130 or continuous body 160. Instead, the curved member 118 is magnetic, such that a magnetic collar 170 can attach to the curved member 118 to secure a pet 10 to the device 100. It is contemplated that the collar 170 is adjustable, and features all common features of conventional dog collars known in the art, such as an adjustable buckle, a clip, a prong and a plurality of continuous openings, etc. Further, the collar 170 may be comprised of a fabric, such as but not limited to: vinyl, canvas, cashmere, chenille, chiffon, cotton, damask, jersey, lace, linen, wool, modal, polyester, satin, silk, spandex, suede, tweed, twill, velvet, acrylic, modacrylic, nylon, polypropylene, polyurethane, polyvinyl chloride, polyethylene, vinylidene, benzoate, aramid, rayon, acetate, triacetate, etc., or any other suitable material as is known in the art, wherein the fabric is flexible, semi-rigid or rigid. Further, the fabric itself may be magnetic, or may have at least one embedded magnet 172 to allow the collar 170 to attach to the curved member 118.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pet grooming restraint device” and “device” are interchangeable and refer to the pet grooming restraint device 100 of the present invention. In addition, the terms “pet” and “animal” are interchangeable and refer to any type of animal that may be owned.

Notwithstanding the forgoing, the pet grooming restraint device 100 of the present invention and its various components can be of any suitable size and configuration as is known in the art without affecting the overall concept of the invention, provided that they accomplish the above-stated objectives. One of ordinary skill in the art will appreciate that the size, configuration and material of the pet grooming restraint device 100 as shown in FIGS. 1-7 is for illustrative purposes only, and that many other sizes and shapes of the pet grooming restraint device 100 are well within the scope of the present disclosure. Although the dimensions of the pet grooming restraint device 100 are important design parameters for user convenience, the pet grooming restraint device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet grooming restraint device comprising:
a base comprising a bottom member;
a pair of frame arms positioned on the bottom member, wherein the pair of frame arms are further comprised of an inner sleeve and an outer sleeve;
a curved member that receives a neck of a pet;
a pin;
a first curved member connected to the curved member via at least one hinge; and
a second curved member connected to the curved member via at least one hinge.

2. The pet grooming restraint device of claim 1, wherein the bottom member can magnetically attach to a grooming table.

3. The pet grooming restraint device of claim 1, wherein the bottom member can fixedly attach to a grooming table via a through hole and a mechanical fastener.

4. The pet grooming restraint device of claim 2, wherein the first curved member and the second curved member are secured around a neck of a pet that is being groomed on the grooming table and the first curved member and the second curved member prevent the pet from moving or struggling.

5. The pet grooming restraint device of claim 2, wherein the pet grooming restraint device is height adjustable via the pin placed into a continuous opening on the outer sleeve of the pair of frame arms.

6. A pet grooming restraint device comprising:
a base comprising a bottom member;
a pair of frame arms positioned on the bottom member, wherein the pair of frame arms are comprised of an inner sleeve and an outer sleeve with at least one continuous opening;
a curved member that receives a neck of a pet;
a pin that can be placed into the at least one continuous opening of the outer sleeve;
a first curved member connected to the curved member that receives the neck of the pet via at least one hinge, wherein a top surface of the first curved member is comprised of at least one magnet and wherein the first curved member is secured around the neck of the pet; and
a second curved member connected to the curved member that receives the neck of the pet via at least one hinge, wherein a bottom surface of the second curved member is comprised of at least one magnet and wherein the second curved member is secured around the neck of the pet.

7. The pet grooming restraint device of claim 6, wherein the first curved member and the second curved member are fixedly or removably attached to the curved member that receives the neck of the pet via at least one hinge located on a first end of the first curved member and a first end of the second curved member.

8. The pet grooming restraint device of claim 6, wherein a bottom surface of the first curved member and a bottom surface of the second curved member are comprised of a padding.

9. The pet grooming restraint device of claim 6, wherein the bottom member can magnetically attach to or be fixedly attached to a grooming table via at least one mechanical fastener.

10. The pet grooming restraint device of claim 6, wherein the pin can be inserted into the at least one continuous opening of the outer sleeve to allow a user to adjust a height of the pet grooming restraint device.

11. The pet grooming restraint device of claim 6, wherein the first curved member and the second curved member are secured around the neck of the pet that is being groomed on a grooming table and the first curved member and the second curved member prevent the pet from moving or struggling.

12. The pet grooming restraint device of claim 6, wherein the first curved member and the second curved member are secured together via at least one magnet on the first curved member and at least one magnet on the second curved member.

13. The pet grooming restraint device of claim 12, wherein the at least one magnet is located on a top surface of the first curved member and the other at least one magnet is located on a bottom surface of the second curved member.

14. The pet grooming restraint device of claim 6, wherein the first curved member and the second curved member are flexible, semi-rigid, or rigid.

15. A pet grooming restraint device comprising:
a base comprising a bottom member;
a pair of frame arms positioned on the bottom member, wherein the pair of frame arms are further comprised of an inner sleeve and an outer sleeve with at least one continuous opening;
a curved member;
a pin that can be placed into the at least one continuous opening of the outer sleeve;
a continuous body that secures to the curved member; and
a magnetic collar.

16. The pet grooming restraint device of claim 15, wherein the continuous body is comprised of an adjustable clasp to allow the continuous body to be secured around a neck of a pet.

17. The pet grooming restraint device of claim 15, wherein the continuous body is comprised of an adjustable buckle to allow the continuous body to be secured around a neck of a pet.

18. The pet grooming restraint device of claim 15, wherein the continuous body is comprised of a prong and a plurality of continuous openings to allow the continuous body to be secured around a neck of a pet.

19. The pet grooming restraint device of claim 15, wherein the magnetic collar can be secured around a neck of a pet and the magnetic collar can magnetically attach to the curved member.

20. The pet grooming restraint device of claim 15, wherein the magnetic collar is flexible, semi-rigid or rigid.
